(19) United States
(12) Patent Application Publication
(10) Pub. No.: US 2020/0183415 A1
(43) Pub. Date: Jun. 11, 2020

(54) SYSTEM AND METHOD FOR CONTROL OF AN AUTONOMOUS VEHICLE

(71) Applicant: GM GLOBAL TECHNOLOGY OPERATIONS LLC, Detroit, MI (US)

(72) Inventors: Omer Tsimhoni, Bloomfield Hills, MI (US); Fan Bai, Ann Arbor, MI (US); Donald K. Grimm, Utica, MI (US); Bo Yu, Troy, MI (US)

(21) Appl. No.: 16/214,535

(22) Filed: Dec. 10, 2018

(51) Int. Cl. G05D 1/02; G05D 1/00; H04W 4/46; H04W 4/48; G08G 1/0968; H04W 4/029; H04W 4/02

(52) U.S. Cl. CPC G05D 1/0276; G05D 1/0088; H04W 4/46; G05D 2201/0213; G08G 1/096811; H04W 4/029; H04W 4/023; H04W 4/48

(57) ABSTRACT

A method of controlling a vehicle includes receiving a first signal from a user device, which indicates motion of the user device. The method additionally includes receiving first sensor data, which indicates motion of a feature external to the vehicle. The method also includes processing, via a controller, the first sensor data to compare the motion of the user device with the motion of the feature external to the vehicle. The method further includes communicating, via the controller, a second signal to the user device. The second signal indicates motion of the vehicle. The method additionally includes receiving a third signal from the user device. The third signal indicates a correlation between the motion of the vehicle and a motion observed by the user device. The method further includes selectively controlling, via the controller, the vehicle towards the feature based on the processing and on the receiving the third signal.

### INTRODUCTION

The present disclosure relates to vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

A method of controlling a vehicle according to the present disclosure includes receiving a first signal from a user device. The first signal indicates motion of the user device. The method additionally includes receiving first sensor data. The first sensor data indicates motion of a feature external to the vehicle. The method also includes processing, via a controller, the first sensor data to compare the motion of the user device with the motion of the feature external to the vehicle. The method further includes communicating, via the controller, a second signal to the user device. The second signal indicates motion of the vehicle. The method additionally includes receiving a third signal from the user device. The third signal indicates a correlation between the motion of the vehicle and a motion observed by the user device. The method further includes selectively controlling, via the controller, the vehicle towards the feature based on the processing and on receiving the third signal.

In an exemplary embodiment, the first signal comprises a first six-degree-of-freedom time sequence, the first sensor data comprises a second six-degree-of-freedom time sequence, and the processing comprises a bi-partite graph matching algorithm between the first time sequence and the second time sequence.

In an exemplary embodiment, the method additionally includes locating, via the controller, the user device. In such embodiments, the locating comprises a first determination of the user device location using a two-way communication channel between the controller and the user device and a second determination of the user device location using an inferential communication channel by the controller.

In an exemplary embodiment, the method additionally includes communicating, via the controller, vehicle locating information to the user device. The vehicle locating information contains human-readable directions from the feature to the vehicle.

In an exemplary embodiment, the second signal includes a visual light signal. The visual light signal may include an encoded signal communicated via headlights or tail lights of the vehicle.

In an exemplary embodiment, the method additionally includes communicating a gesture request to the user device. In such an embodiment, the receiving the first signal from the user device is in response to the gesture request.

An automotive vehicle according to an embodiment of the present disclosure includes at least one actuator configured to control vehicle steering, shifting, acceleration, or braking, at least one sensor configured to detect a feature external to the vehicle, a wireless communication device configured to communicate with a user device external to the vehicle, and a controller in communication with the at least one actuator, the at least one sensor, and the wireless communication device. The controller is configured to selectively control the at least one actuator according to an autonomous driving mode. The controller is also configured to receive a first signal via the wireless communication device and first sensor data via the at least one sensor. The first signal indicates motion of the user device, and the first sensor data indicates motion of the feature external to the vehicle. The controller is additionally configured to process the first sensor data to compare the motion of the user device with the motion of the feature external to the vehicle. The controller is further configured to communicate a second signal via the wireless communication device to the user device and to receive a third signal via the wireless communication device. The second signal indicates motion of the vehicle, and the third signal indicates a correlation between the motion of the vehicle and a motion observed by the user device. The controller is further configured to control the actuator in the autonomous driving mode to maneuver the vehicle towards the feature based on the processing and on the third signal.

In an exemplary embodiment, the first signal comprises a first six-degree-of-freedom time sequence, the first sensor data comprises a second six-degree-of-freedom time sequence, and the controller is configured to process the first sensor data using a bi-partite graph matching algorithm between the first time sequence and the second time sequence.

In an exemplary embodiment, the controller is further configured to receive second sensor data via the at least one sensor and receive a fourth signal via the wireless communication device. The second sensor data includes a first determination of a user device location received, the fourth signal includes a second determination of the user device location, and the controller is further configured to locate the user device based on the first determination and the second determination. In such an embodiment, the fourth signal may include an image captured by the user device, and the controller may be configured to locate the device by recognizing at least one feature contained in the image or video and associating the at least one feature with a known geolocation.

In an exemplary embodiment, the controller is further configured to communicate, via the wireless communication device, vehicle locating information to the user device. The vehicle locating information contains human-readable directions from the feature to the vehicle.

In an exemplary embodiment, the vehicle additionally includes an externally-oriented light emitter in communication with the controller. In such embodiments, the second signal may include a visual light signal communicated via the light emitter. The light emitter may include a headlight or tail light of the vehicle.

Embodiments according to the present disclosure provide a number of advantages. For example, the present disclosure provides a system and method for mutual localization and identification of an autonomous vehicle and a user of such a vehicle.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure; and

FIG. 3 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

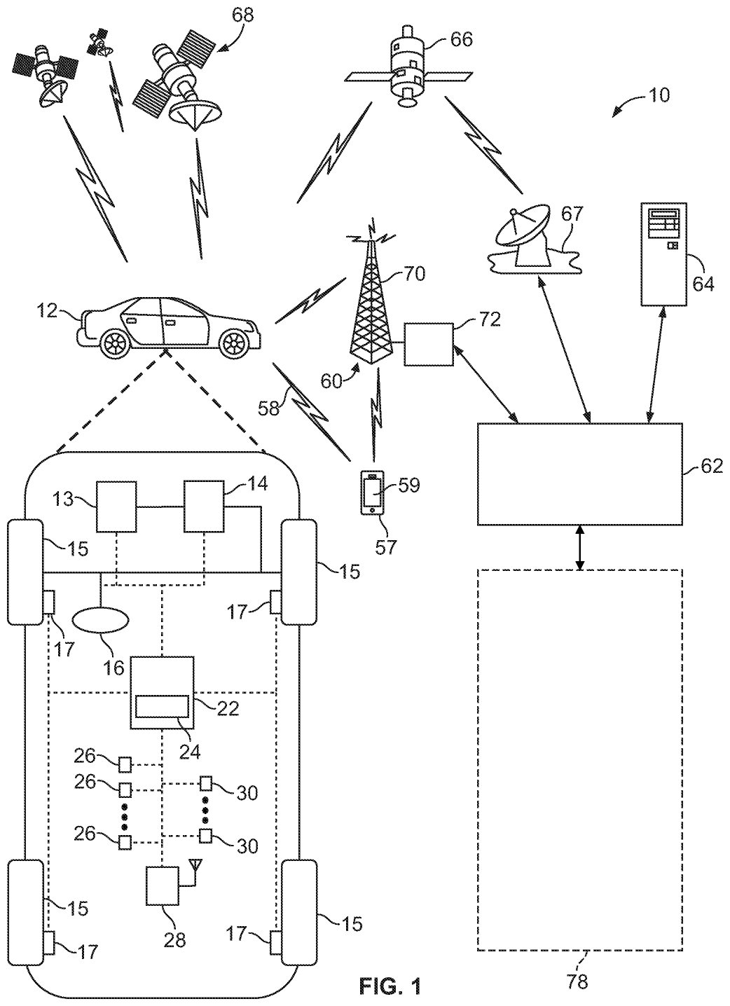

FIG. 1 schematically illustrates an operating environment that comprises a mobile vehicle communication and control system 10 for a motor vehicle 12. The motor vehicle 12 may be referred to as a host vehicle. The communication and control system 10 for the host vehicle 12 generally includes one or more wireless carrier systems 60, a land communications network 62, a computer 64, a mobile device 57 such as a smart phone, and a remote access center 78.

The host vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The host vehicle 12 includes a propulsion system 13, which may in various embodiments include an internal combustion engine, an electric machine such as a traction motor, and/or a fuel cell propulsion system.

The host vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The host vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The host vehicle 12 additionally includes a steering system 16. While depicted as including a steering wheel for illustrative purposes, in some embodiments contemplated within the scope of the present disclosure, the steering system 16 may not include a steering wheel.

The host vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 (“WiFi™”) and cellular data communication, are also considered within the scope of the present disclosure. Furthermore, in an exemplary embodiment, the wireless communications system 28 comprises a headlight or tail light configured to transmit an encoded visual light signal, as will be discussed in further detail below.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

Other embodiments according to the present disclosure may be implemented in conjunction with so-called Level One, Level Two, or Level Three automation systems. A Level One system indicates “driver assistance”, referring to the driving mode-specific execution by a driver assistance system of either steering or acceleration using information about the driving environment and with the expectation that the human driver perform all remaining aspects of the dynamic driving task. A Level Two system indicates “Partial Automation”, referring to the driving mode-specific execution by one or more driver assistance systems of both steering and acceleration using information about the driving environment and with the expectation that the human driver perform all remaining aspects of the dynamic driving task. A Level Three system indicates “Conditional Automation”, referring to the driving mode-specific performance by an automated driving system of all aspects of the dynamic driving task with the expectation that the human driver will respond appropriately to a request to intervene.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the host vehicle 12. One of the networked devices that can communicate with the host vehicle 12 via the wireless communication system 28 is the mobile device 57. The mobile device 57 can include computer processing capability, a transceiver capable of communicating signals 58 using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving signals from GPS satellites 68 and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The mobile device 57 may also include other sensors, including but not limited to, accelerometers, gyroscopes, compasses, and/or other sensors capable of measuring motion of the mobile device 57 along six axes. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide unidirectional or bidirectional communication with the host vehicle 12. This can be done using one or more communication satellites 66 and an uplink transmitting station 67. Unidirectional communication can include, for example, satellite radio services, wherein programming content (news, music, etc.) is received by the transmitting station 67, packaged for upload, and then sent to the satellite 66, which broadcasts the programming to subscribers. Bidirectional communication can include, for example, satellite telephony services using the satellite 66 to relay telephone communications between the host vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the host vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the host vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the host vehicle 12. The computer 64 may be in communication with at least one supplemental vehicle in addition to the host vehicle 12. The host vehicle 12 and any supplemental vehicles may be collectively referred to as a fleet. In an exemplary embodiment, the computer 64 is configured to store, e.g. in non-transient data memory, subscriber account information and/or vehicle information. The subscriber account information can include, but is not limited to, biometric data, password information, subscriber preferences, and learned behavioral patterns of users or occupants of vehicles in the fleet. The vehicle information can include, but is not limited to, vehicle attributes such as color, make, model, license plate number, notification light pattern, and/or frequency identifiers.

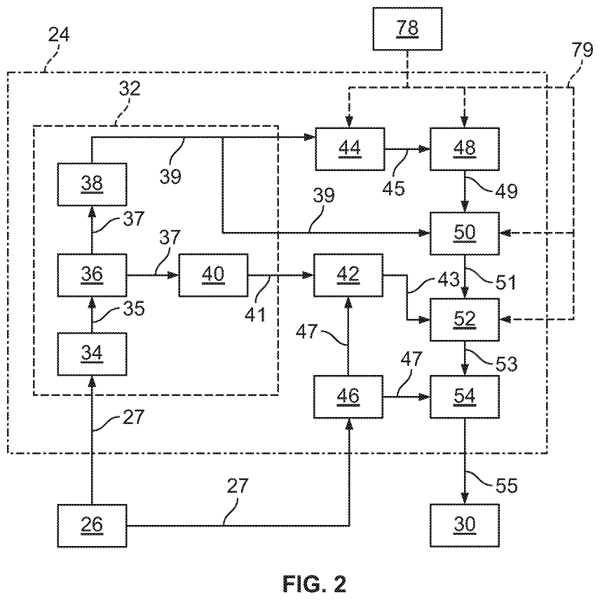

As shown in FIG. 2, the ADS 24 includes multiple distinct systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of the host vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the host vehicle 12 during operation and mapping data “pushed” to the host vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the host vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

In some embodiments, the vehicle 12 may operate as a taxi, or otherwise be required to pick up a passenger. In such embodiments, a registered user can create a ride request, e.g. via the mobile device 57. The ride request will typically indicate the user's desired pickup location (or current GPS location), the desired destination location (which may identify a predefined vehicle stop and/or a user-specified destination), and a pickup time. The computer 64 receives the ride request, processes the request, and dispatches a selected vehicle of the fleet (when and if one is available), e.g. the host vehicle 12, to pick up the user at the designated pickup location and at the appropriate time. The computer can also generate and send a suitably configured confirmation message or notification to the mobile device 57, to let the user know that the vehicle is on the way.

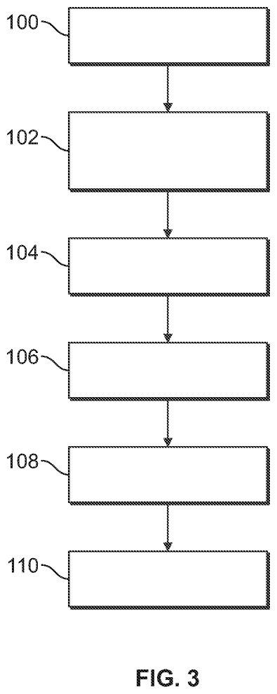

As the vehicle approaches the registered user, it is desirable for the user to identify the vehicle and for the vehicle to identify the user. As shown in more detail with regard to FIG. 3 and with continued reference to FIGS. 1 and 2, a flowchart illustrates a method of user interaction in accordance with an exemplary embodiment of the present disclosure. As can be appreciated in light of the disclosure, the order of operation within the method is not limited to the sequential execution as illustrated in FIG. 3, but may be performed in one or more varying orders as applicable and in accordance with the present disclosure. In various embodiments, the method may be scheduled to run upon request by a user of a ride in one of the vehicles of the fleet.

A ride request is received, as illustrated at block 100. As discussed above, the ride request may be communicated by a user to the computer 64, e.g. via a mobile device 57.

Upon receipt of the ride request, a mutual communication phase is initiated, as illustrated at block 102. In the mutual communication phase, the vehicle 12 and the user communicate to determine a rendezvous pattern. A rendezvous pattern refers to the general strategy employed by the vehicle 12 and the user to arrive at a common location. In an exemplary embodiment, the communication comprises one or more user inputs to the mobile device 57. Various exemplary rendezvous patterns include a stationary passenger pattern, wherein the vehicle 12 navigates to the current location of the user, a mid-point rendezvous, wherein the vehicle 12 and user communicate to determine a midpoint between the initial location of the vehicle 12 and the initial location of the user at which to meet, and a progressive approach, wherein the vehicle 12 and user move toward one another while maintaining communication for continuously refined localization.

Upon determination of the rendezvous pattern, a mutual localization phase is initiated, as illustrated at block 104. In the mutual localization phase, the vehicle 12 localizes and tracks the user, e.g. via the mobile device 57, while progressing to the selected meeting location. Likewise, the user localizes and tracks the vehicle 12, e.g. via the mobile device 57, while progressing to the selected meeting location. In an exemplary embodiment, the mutual localization phase is performed via at least two distinct localization channels, with at least one channel being an explicit channel and at least one channel being an implicit channel.

An explicit channel refers to a channel of unidirectional or bidirectional communication between the vehicle 12 and the user whereby a party communicates its precise location, either as an absolute location or relative to the other party or other landmark, to the other party. A first explicit channel may be provided for relatively long range localization and a second explicit channel may be provided for relatively short range localization. In an exemplary embodiment, the location of the vehicle 12, e.g. as determined by an on-board GPS, and the location of the user, e.g. as determined by a GPS of the mobile device 57, are bidirectionally communicated between the vehicle 12 and the user via the computer 64 for long-range localization. Likewise, in an exemplary embodiment, the location of the vehicle 12 and the location of the user are bidirectionally communicated directly between the vehicle 12 and the mobile device 57, e.g. via IEEE 802.11 or DSRC, for short-range localization. In such embodiments, for short-range localization, a relative distance and angle between the vehicle 12 and the mobile device 57 may be obtained directly from the wireless communications, e.g. using the multiple signal classification (“MUSIC”) algorithm.

An implicit channel refers to a method of unidirectional or bidirectional communication between the vehicle 12 and the user whereby a party's location may be inferred based on non-location-specific information. In an exemplary embodiment, the implicit channel includes photo geolocation. In such an embodiment, the user may capture an image or video, e.g. via the mobile device 57. The image or video may be processed, e.g. by the processor 24 of the vehicle 12 or by the computer 64, to recognize features contained in the image or video, e.g. points of interest, having known geolocations. The location of the user may thereby be inferred based on the geolocations of the recognized features and based on the camera perspective. In another exemplary embodiment, the implicit channel includes encoded visual light communication. In such an embodiment, the vehicle 12 may communicate encoded light pulses via head lights or tail lights, and additionally communicate the encoding scheme along with other identifying information such as make and model via wireless communications such as IEEE 802.11, DSRC, or cellular communications. A camera, e.g. of the mobile device 57, may be used to capture the encoded light pulses, which may subsequently be compared against the communicated encoding scheme to identify the vehicle 12. The location of the vehicle 12 may thereby be obtained based on the position of the vehicle within the field of view of the camera.

Upon reaching the rendezvous zone, a mutual identification phase is initiated, as illustrated at block 106. In the mutual identification phase, the vehicle 12 and the user use two separate and orthogonal channels to identify one another. In an exemplary embodiment, the mutual identification phase comprises a first bi-partite graph matching algorithm for identifying the user and a second bi-partite graph matching algorithm for identifying the vehicle 12. The first bi-partite graph matching algorithm may be implemented by matching a first six-degree-of-freedom time sequence observed via an implicit camera domain against a second six-degree-of-freedom time sequence reported via an explicit wireless domain. As used herein, a six-degree-of-freedom time sequence refers to a data packet comprising information describing translational and rotational motion of a body relative to three orthogonal axes during a particular time period. As an example, the mobile device 57 may provide the second six-degree-of-freedom time sequence based on measurements received from the sensors in the mobile device 57, and the vehicle 12 may measure the first six-degree-of-freedom time sequence based on observations of motion of the user and/or the mobile device 57. Likewise, the second bi-partite graph matching algorithm may be implemented by matching a third six-degree-of-freedom time sequence observed via an implicit camera domain against a fourth six-degree-of-freedom time sequence reported via an explicit wireless domain. As an example, the vehicle 12 may provide the fourth six-degree-of-freedom time sequence based on measurements received from accelerometers in the vehicle 12, and the mobile device 57 may measure the third six-degree-of-freedom time sequence based on observations of motion of the vehicle 12. Furthermore, the mutual identification phase may comprise a gesture request step, wherein the vehicle 12 communicates a request via the mobile device 57 that the user perform a particular gesture and/or the mobile device 57 communicates a request that the vehicle 12 perform a particular gesture. As used herein, a gesture refers to a specified pattern of six-degree-of-freedom motion. As nonlimiting examples, a gesture may refer to travelling in a specified direction, travelling a specified distance, or performing other specified motions, such as the user moving the mobile device in a specified pattern such as a wave. The responsive gesture may thereby be evaluated using the above-described verification process.

Upon mutual identification, a mutual verification phase is initiated, as illustrated at block 108. In the mutual verification phase, the vehicle 12 and the user conduct a final verification to confirm identification of one another. In an exemplary embodiment, the mutual verification phase comprises a five-way handshake utilizing multiple distinct communications channel. The verification phase may comprise a verification request communicated via a wireless communication channel such as 802.11 or DSRC, wherein the vehicle 12 self-reports a GPS location and a visual descriptor or other information regarding the vehicle 12. The verification phase may subsequently comprise a visual light communication synchronization request, wherein the mobile device 57, upon verification of the information communicated in the verification request, communicates a synchronization signal via visual light communication. The verification phase may subsequently comprise a visual light communication acknowledgement signal, wherein the vehicle 12, in response to the synchronization signal, communicates an acknowledgement signal via visual light communication. The visual light communication synchronization request and the visual light communication acknowledgement signal may thereby function as a secure channel to complement the wireless communication. The verification phase may subsequently comprise a request acknowledgement signal communicated via the wireless communication channel, wherein the mobile device 57 communicates an acknowledgement that the verification request has been received and that the information contained therein has been validated. The verification phase may subsequently comprise a verification acknowledgement communicated via the wireless communication channel, wherein the vehicle 12 communicates an acknowledgement that the mobile device 57 has verified the information communicated in the verification request.

Upon successful completion of the mutual verification phase, the vehicle 12 proceeds to pick up the user, as illustrated at block 110, e.g. by autonomously navigating to a position proximate the user and automatically unlocking vehicle doors to enable the user to enter the vehicle 12.

As may be seen, the present disclosure provides a system and method for mutual localization and identification of an autonomous vehicle and a user of such a vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle, comprising:
receiving a first signal from a user device, the first signal indicating motion of the user device;
receiving first sensor data, the first sensor data indicating motion of a feature external to the vehicle;
processing, via a controller, the first sensor data to compare the motion of the user device with the motion of the feature external to the vehicle;
communicating, via the controller, a second signal to the user device, the second signal indicating motion of the vehicle;
receiving a third signal from the user device, the third signal indicating a correlation between the motion of the vehicle and a motion observed by the user device; and
selectively controlling, via the controller, the vehicle towards the feature based on the processing and on the receiving the third signal.

2. The method of claim 1, wherein the first signal comprises a first six-degree-of-freedom time sequence, the first sensor data comprises a second six-degree-of-freedom time sequence, and the processing comprises a bi-partite graph matching algorithm between the first time sequence and the second time sequence.

3. The method of claim 1, further comprising locating, via the controller, the user device, wherein the locating comprises a first determination of the user device location using a two-way communication channel between the controller and the user device and a second determination of the user device location using an inferential communication channel by the controller.

4. The method of claim 1, further comprising communicating, via the controller, vehicle locating information to the user device, the vehicle locating information comprising human-readable directions from the feature to the vehicle.

5. The method of claim 1, wherein the second signal comprises a visual light signal.

6. The method of claim 5, wherein the visual light signal comprises an encoded signal communicated via headlights or tail lights of the vehicle.

7. The method of claim 1, further comprising communicating a gesture request to the user device, wherein the receiving the first signal from the user device is in response to the gesture request.

8. An automotive vehicle comprising:
at least one actuator configured to control vehicle steering, shifting, acceleration, or braking;
at least one sensor configured to detect a feature external to the vehicle;
a wireless communication device configured to communicate with a user device external to the vehicle; and
a controller in communication with the at least one actuator, the at least one sensor, and the wireless communication device, the controller being configured to selectively control the at least one actuator according to an autonomous driving mode, the controller being further configured to receive a first signal via the wireless communication device and first sensor data via the at least one sensor, the first signal indicating motion of the user device, the first sensor data indicating motion of the feature external to the vehicle, the controller being further configured to process the first sensor data to compare the motion of the user device with the motion of the feature external to the vehicle, the controller being further configured to communicate a second signal via the wireless communication device to the user device and to receive a third signal via the wireless communication device, the second signal indicating motion of the vehicle, the third signal indicating a correlation between the motion of the vehicle and a motion observed by the user device, the controller being further configured to control the actuator in the autonomous driving mode to maneuver the vehicle towards the feature based on the processing and on the third signal.

9. The automotive vehicle of claim 8, wherein the first signal comprises a first six-degree-of-freedom time sequence, the first sensor data comprises a second six-degree-of-freedom time sequence, and wherein the controller is configured to process the first sensor data using a bi-partite graph matching algorithm between the first time sequence and the second time sequence.

10. The automotive vehicle of claim 8, wherein the controller is further configured to receive second sensor data via the at least one sensor and receive a fourth signal via the wireless communication device, the second sensor data including a first determination of a user device location received, the fourth signal including a second determination of the user device location, the controller being further configured to locate the user device based on the first determination and the second determination.

11. The automotive vehicle of claim 10, wherein the fourth signal comprises an image captured by the user device, and wherein the controller is configured to locate the device by recognizing at least one feature contained in the image or video and associating the at least one feature with a known geolocation.

12. The automotive vehicle of claim 8, wherein the controller is further configured to communicate, via the wireless communication device, vehicle locating information to the user device, the vehicle locating information comprising human-readable directions from the feature to the vehicle.

13. The automotive vehicle of claim 8, further comprising an externally-oriented light emitter in communication with the controller, wherein the second signal comprises a visual light signal communicated via the light emitter.

14. The automotive vehicle of claim 12, wherein the light emitter comprises a headlight or tail light of the vehicle.
